(19) United States
(12) Patent Application Publication
(10) Pub. No.: US 2004/0230626 A1
(43) Pub. Date: Nov. 18, 2004

(54) Computer system method for a one cycle implementation of test under mask instructions

(75) Inventors: Fadi Y. Busaba, Poughkeepsie, NY (US); Steven R. Carlough, Poughkeepsie, NY (US); Christopher A. Krygowski, Lagrangeville, NY (US); Wen H. Li, Poughkeepsie, NY (US); John G. Rell, JR., Saugerties, NY (US)

Correspondence Address: Lynn L. Augspurger, IBM Corporation, 2455 South Road, P386, Poughkeepsie, NY, 12601, US

(73) Assignee: International Business Machines Corporation, Armonk, NY (US)

(21) Appl. No.: 10/436,211

(22) Filed: May 12, 2003

(51) Int. Cl. G06F 7/38

(52) U.S. Cl. 708/233

(57) ABSTRACT

In a computer system, a method for executing a Test under Mask instruction in the Fixed Execution Unit (FXU) allows for the execution of these instructions in just one cycle single execution cycle inside the FXU without adding any dedicated data flow circuitry by giving the highest priority to the leftmost selected bit in the operand. The preferred method breaks the execution of each instruction into four different micro-operations that can be executed in parallel in one CPU cycle, and during the E0 cycle of these instructions, data from a first operand and from the Test under Mask instruction are loaded into the two working registers, an A-reg and a B-reg, and then, during the E1 dispatch cycle, the A-reg is rotated by the amount of 32-bits to align the bits of the mask with the corresponding bits of the first operand, and during the same E1 dispatch cycle micro-operations are executed in the Fixed Execution Unit (FXU) giving the highest priority to the leftmost selected bit in the operand and the outcome of these micro-operations is used to calculate the condition code (CC) to implement the Test under Mask as a one-cycle implementation for test under mask instructions and the results of the execution sets the condition code.

### FIELD OF THE INVENTION

This invention relates to computer architecture and particularly to implementation of the Test under Mask instruction of IBM's architecture as used by IBM and others.

Trademarks: IBM® is a registered trademark of International Business Machines Corporation, Armonk, N.Y., U.S.A. Other names may be registered trademarks or product names of International Business Machines Corporation or other companies.

### BACKGROUND

IBM's Test Under Mask is known in the patent literature, see e.g. “Test Under Mask High instruction” and “Test Under Mask Low” instruction executing method and apparatus, U.S. Pat. No. 6,122,730, Sep. 19, 2000 to Hitachi Ltd and Hitachi Information Technology Co. Ltd. IBM's z/architecture “Principles of Operations”, SA22-7832-00, Chapter 7 details the different variants of the test under mask instructions.

It is common in a computer system to have instructions test certain bit(s) in an operand and set the condition code accordingly. The bit(s) to be tested are either specified explicitly in the instruction text, e.g., bit-5 of the operand, or implicitly by an instruction mask field. Several instructions are typically required to test many non-adjacent bits of an operand in a prioritized order. In addition to the noted IBM's z/architecture “Principles of Operations”'s variants of the test under mask instructions, an additional IBM instruction, TMY, has also been added in Logic-Displacement Facility for Z architecture which is implemented in accordance with the method of the preferred embodiment. In accordance therewith the execution of instruction TMY is made identical to that of the TM instruction. TMY only differs on memory address generation that is calculated in the Instruction Unit (I-unit). The Y in the TMY instruction refers to an instruction for a CPU with a Long Displacement Facility, where the displacement is indicated with 20 bits, instead of the 12 bits used in the TM instruction.

### SUMMARY OF THE INVENTION

In accordance with our invention, we have provided implementation of a method of test under mask instructions in a single execution cycle inside the FXU without adding any dedicated data flow circuitry. The preferred implementation of our invention provides a method which allows for the execution of these instructions in just one cycle giving the highest priority to the leftmost selected bit in the operand. The presented method breaks the execution of each instruction into four different micro-operations that can be executed in parallel in one CPU cycle with only one non critical timing modification (AND gate (1) and OR gate (2) of FIG. 4) to the BLU_AIM macro. The micro-operations are executed in the FXU during the E1 cycle and utilize the existing data flow logic unit; namely, the instructions utilizes the 64-bit rotator, BLU_AIM and the zero-detection circuits. The presented technique also utilizes the existing muxing into working registers without adding any new multiplexes or buses. During the E0 cycle of these instructions, data from the first operand and from the instruction are loaded into the two working registers A-reg and B-reg. During the E1 cycle, the A-reg is rotated by the amount of 32-bits to align the bits of the mask with the corresponding bits of the first operand. The outcome of these micro-operations is used to calculate the condition code (CC). These micro-operations utilize the high and the low words (32-bits) of the BLU_AIM in a unique manner. This technique can be generalized to other computer systems other than that implemented now in accordance with IBM's principles of operation and is applicable to any computer system which has processors which have bit logical operations as well as mask and merge operations.

The advantages of using this technique are:

1. Simple control that results in a quick and error-free implementation.

2. Utilization of the existing FXU data flow sub-circuits result in saving area that is crucial for super scalar FXU design.

3. There is no impact on cycle time since only one change (two additional gates) in a non-critical path in BLU_AIM custom macros necessary for the implementation.

### DESCRIPTION OF THE DRAWINGS

FIG. 1 illustrates the pipeline stages.

FIG. 2 shows the FXU data flow for the three pipeline superscalar “z” processor where test under mask instructions are implemented.

FIG. 2A shows a list of test under mask instructions in accordance with our preferred embodiment of our present invention, which can be compared to FIG. 2B.

FIG. 2B shows Test under Mask instructions of Chapter 7, General Instructions 7-147 TEST UNDER MASK (TEST UNDER MASK HIGH, TEST UNDER MASK LOW) of the z900 z/Architecture Principles of Operation SA22-7832-00.)

FIG. 3 shows the setting of condition code for test under mask instructions.

FIG. 4 illustrates logic diagram for the BLU_AIM macro with the modification at (1) and (2).

FIG. 5 illustrates how the mask start and mask end are set during EM1 cycle.

FIG. 6 illustrates the ingating to A and B working registers during E0 cycle.

FIG. 7 shows how TMHL instruction in our preferred embodiment is implemented.

FIG. 8 illustrates the use of the TEST UNDER MASK (TM) instruction illustrated in the Appendix A-31 of the z900 z/architecture Principles of Operation SA22-7832-00.

Our detailed description explains the preferred embodiments of our invention, together with advantages and features, by way of example with reference to the drawings.

### DETAILED DESCRIPTION OF THE INVENTION

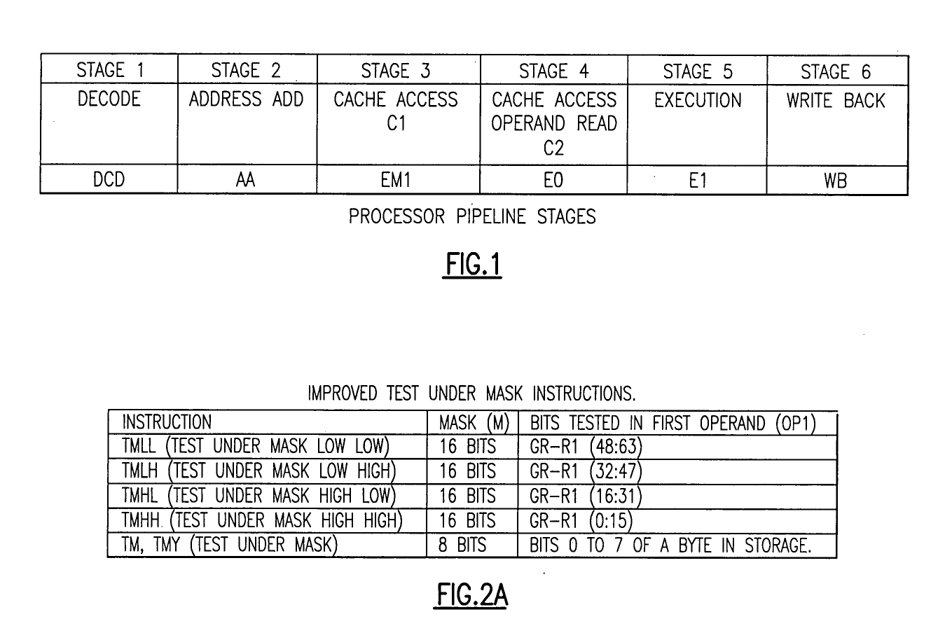

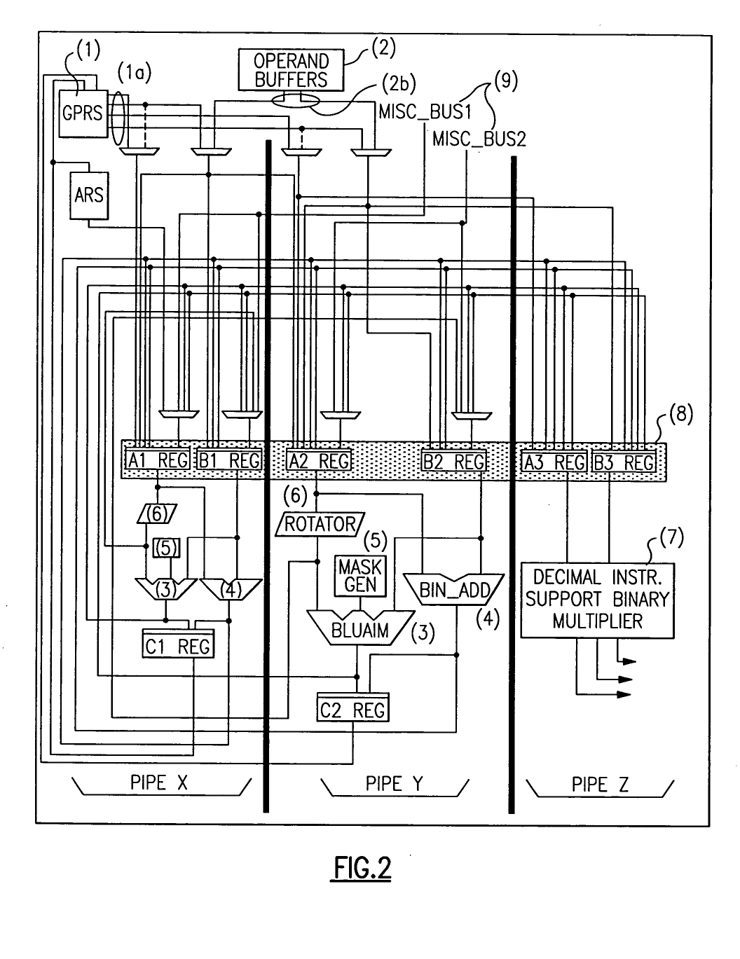

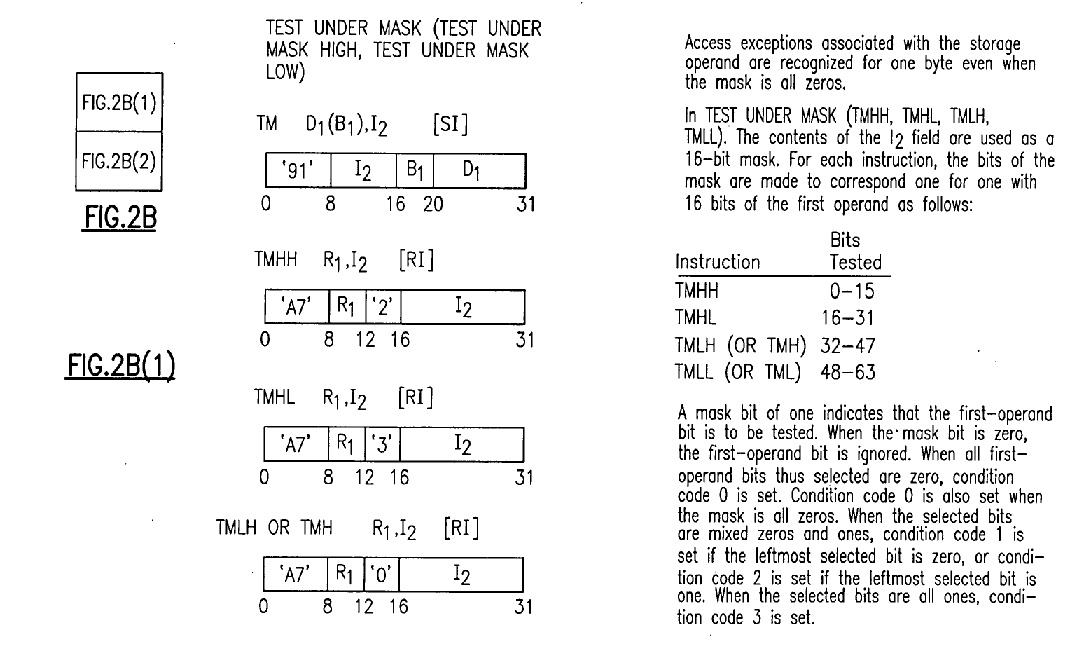

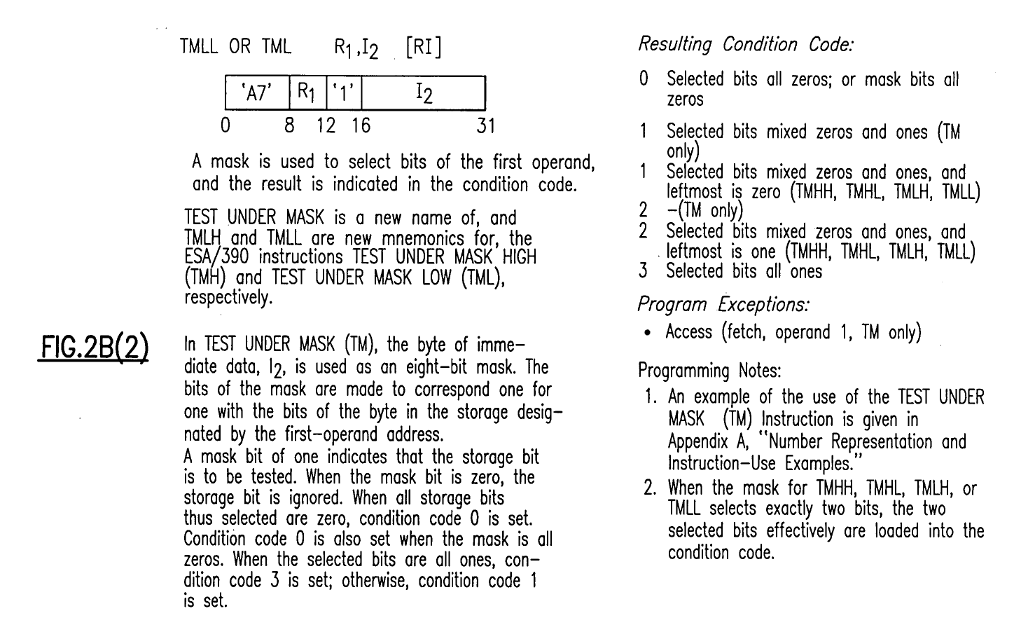

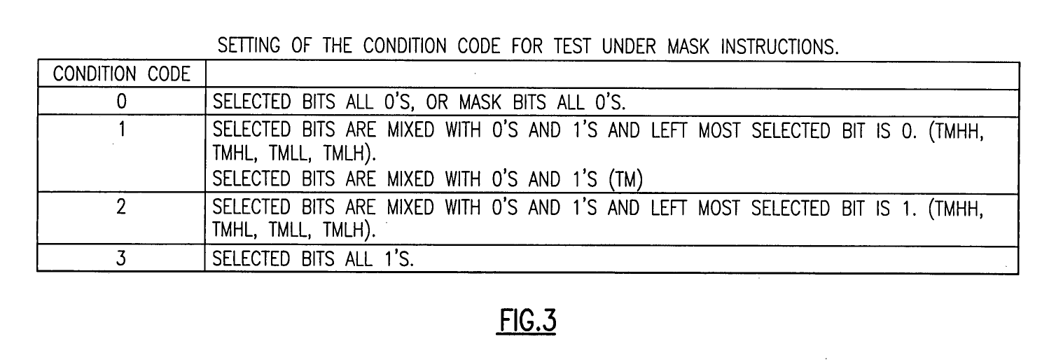

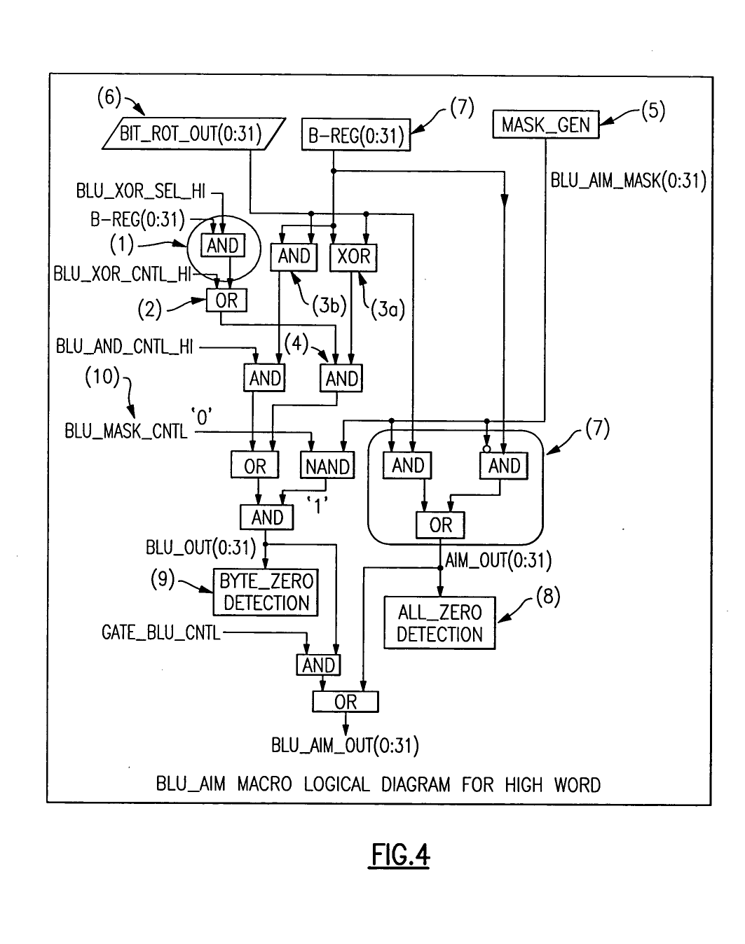

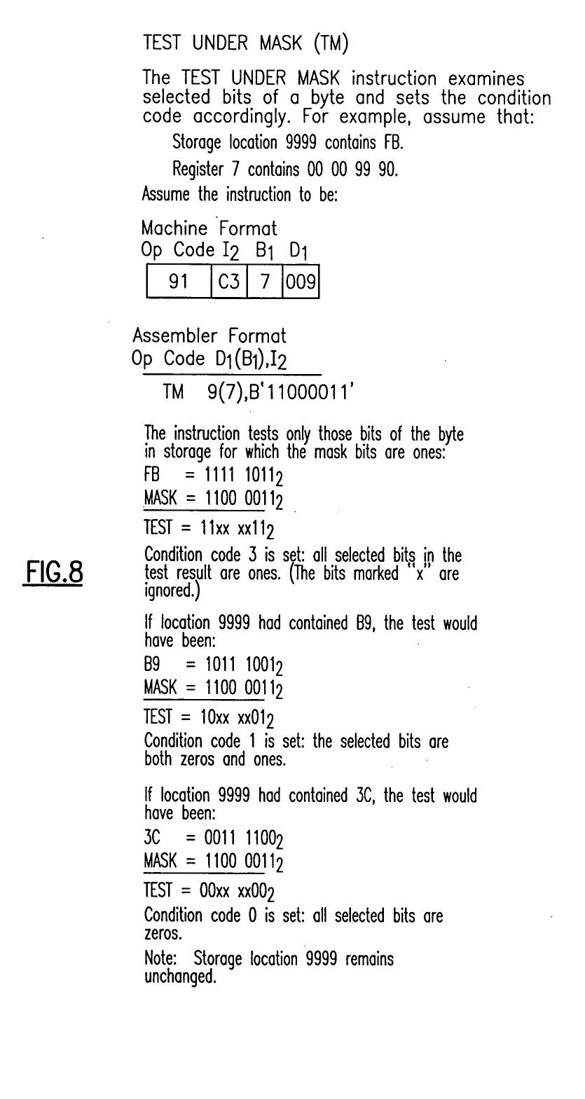

As an introduction, in the environment in which our preferred embodiment is used in a super scalar processor, test under mask instructions are commonly executed as super scalar operations. “Super scalar” means that these instructions can be issued with other instructions and only require one cycle of execution inside the Fixed Point Unit (FXU). FIG. 2 shows a diagram of the FXU data flow where our invention is implemented. IBM in its prior z900 products as described by E. Schwartz et al in the IBM's Journal of Research & Development Vol. 46 (2002) p 464 entitled “The micro-architecture of the IBM eServer z900 processor”. implemented these instructions we use differently (Research article can be found at http://researchweb.watson.ibm.com/journal/rd/464/schwarz.html). The research article does not provide the way the test under mask instructions were implemented. Instead it describes the Execution nit, specifically The FXU, and shows its data flow in FIG. 8. The FXU in E. Schwartz et. Al article is a single scalar that can only executes single instruction at a time. The FXU data flow where our invention is implemented, see FIG. 2, is a super scalar pipeline consisting of three data flow pipes named Pipe X, Pipe Y and Pipe Z. There are additional requirement on the read and write ports on the General Purpose Register (GPR) (1) and operand buffer (2) to support the execution of many instructions simultaneously. For example, the GPR read ports (1a) has increased from 2 ports to 4. Similarly, the operand buffer (2) read ports (2b) has increased from 1 to 2. All these read ports are 64-bits wide. The multiplex structure into the working registers (8) for the data flow where test under mask instructions are implemented is different from that shown in FIG. 8 of the research article. There are some similarities in the data flow for Pipes X and Y and the data flow of the research article. Each of these pipes has BLU_AIM macro (3), binary adder (4), zero-detect macro (not shown), and two working register (8) A-reg and B-reg. The implementation of the test under mask instructions presented in this patent differs than the one used in the article. First, we changed BLU_AIM macro by adding two logic gates (FIG. 4, gate (1) and gate (2)) to support the implementation of all the instructions in simple and similar manner. The implementation in the cited article relies more in control than in data flow. For example, TM instruction is implemented mainly in control by sending the 8-bit mask and the 8-bit from operand buffer to a control macro where the operand is checked if the selected bits are 0's or 1's. While this describes the Fixed-point Unit and its data flow, for convenience this entire IBM document is incorporated herein by reference.

Test under mask instructions have a mask field that is used to select the bits of the first operand and the result is indicated in the condition code. There are five different variants for Test Under Mask Instruction now in accordance with the preferred embodiment with each testing different bits of the first operand as shown in FIG. 2A (Four Test Under Mask Instructions were in the Principles of Operation cited and shown in FIG. 2B). Four of the instructions have a 16-bit mask testing bits in a General Register and one (for TM, TMY) instruction with an 8-bit mask testing a byte in storage. In the notation used, bit 0 refers to the most significant bit; so a 64-bit register is numbered from bit 0 (most significant) to bit 63 (least significant). TMHH instructions test bits 0:15 of GPR-R1, TMHL tests bits 16:31 of GPR-R1, TMLH tests bits 32:47 of GPR-R1, TMLL test bits 58:63 of GPR-R1 and TM/TMY tests bits 0:7 of a byte in storage at the address specified by operand 1 of the instruction in accordance with the preferred embodiment of our invention. For each instruction, the bits of the mask are made to correspond, one for one, with the bits of the first operand. A mask bit of one indicates that the corresponding first operand bit is to be tested (byte of storage for TM/TMY), while a mask bit of zero ignores the first operand bit. These instructions set the condition code based on the selected bits as detailed in FIG. 3.

While the cited U.S. Pat. No. 6,122,730 of Hitachi claims a high speed execution for these instructions, it describes generic logic and circuits to execute these instructions based on the description given in IBM's z/architecture Principle of Operation. This invention, on the other hand and in contrast to U.S. Pat. No. 6,122,730, provides a detailed uniform implementation method for these instructions, executes the instructions in just one cycle, adds minimal hardware (2 gates AND gate 1 and OR gate 2 of FIG. 4), utilizes the existing the data flow elements that exist in the FXU, and has no impact on cycle time.

The following description is of a computer system pipeline where the test under mask instructions are implemented. The basic pipeline sequence for a single instruction is shown in FIG. 1.

The pipeline does not show the instruction fetch from the Instruction Cache (I-Cache). During the decode stage (DcD), the instruction is decoded, and the B and X registers are read to generate the memory address for the operand fetch. During the Address Add (AA) cycle, the displacement and contents of the B and X registers are added to form the memory address. Two cycles are required to access the Data cache (D-cache) and transfer the data back to the execution unit (C1 and C2 stages) for the processor where the instructions are implemented. Also, during C2 cycle, the register operands are read from the register file and stored in working registers in preparation for execution.

Instruction execution occurs during the E1 stage, and the WB stage is when the result is written back to register file or stored away in the D-cache. Instruction grouping occurs in the AA cycle, and groups are issued during the EM1 cycle, which overlaps with the C1 cycle. A super scalar processor contains multiple execution pipes where instructions are executed. A typical FXU pipe has two input working registers named A-reg and B-reg, a result register, C-reg, a 64-bit binary adder, a 64-bit BLU_AIM macro showing the modification's improvements (1) and (2) to the data flow at non-time critical positions in the path (FIG. 4.), and a leading zero detection macro. FIG. 2 shows the FXU data flow for the processor where our patent is implemented. The above mentioned registers are 64-bits wide provided to support 32-bits as well as 64-bits applications. In addition, the FXU data flow operates on both 32-bit and 64-bit basis. For example, an operand data can be loaded independently into the high word of A-reg (A-reg (0:31)) and the low word of A-reg (A-reg (32:63)). Similarly, different data can be loaded into the high and the low words of the A-reg and B-reg. One of the data inputs to the A-reg/B-reg multiplexors is a misc_bus (0:31) (FIG. 2, input (9)), that is formed in the FXU control by using information such as mask bits from the instruction.

As described earlier, the implementation of the test under mask instructions utilizes the BLU_AIM macro, zero-detecting logic and mutiplexer ingating into the working registers A-reg and B-reg.

The main data inputs to the BLU_AIM macro, shown in FIG. 4., are the output of a 64-bit rotator (6) that rotates the A-reg, the B-reg (7), and a 64-bit blu_aim_mask (5) used for selecting between bits of the bit_rot_out and B-reg (7). The high and low word of the BLU_AIM does not share the same control lines; for example, aim_rot_cnlt_hi gates bit_rot_out (0:31) whereas aim_rot_ctl_lo gates bit_rot_out (32:63). The BLU_AIM is capable of performing logical operations such as ANDing (3b), XORing (3a) and ORing (3a and 3b) between the output of the rotator (6) and the B-reg (7). Blu_out (0:63) is the output from the bit-logical operations. The BLU_AIM, however, is not capable of performing bit ANDing of the compliment of bit_rot_out and B-reg (Not bit_rot_out AND B-reg) which is needed for our implementation of test under mask instructions. In order to perform (Not bit_rot_out AND B-reg), in accordance with the preferred embodiment of our invention we have added minimal hardware in the form an additional AND gate (1), and an additional OR gate (2) are added in the non critical timing paths. The timing critical path in the BLU-AIM is the output of the rotator that feeds the XOR (3a) and AND (3b) gates. starts from A-reg For appropriate control values (blu_xor_sel_hi=‘1’ (1), blu_xor_cntl_hi=‘0’ (2)), AND gate (4) performs the ANDing of B-reg and the output of gate (3a) (bit_rot_out XOR B-reg). The output of gate (4) is then equivalent to (Not bit_rot_out AND B-reg) product. The gating of data into the working registers occur during cycle E0, while the actual computation in the FXU occurs during the E1 cycle. There exist control lines to activate each of these logical functions.

For example, When blu_xor_cntl_hi input to gate (2) is high (or ‘1’), the XOR result output of gate (3a) is enabled at AND gate (4). In addition to logic operations, the BLU_AIM performs merge and mask functions (7). When aim_mux_cntl_hi=‘0’, the output of AND gate (11) will be all 0's and the blu_aim_mask will be merging bit_rot_out (0:63) with a string of all 0's. A ‘1’ in the blu_aim_mask selects the corresponding bit in bit_rot_out (6) whereas a ‘0’ selects the corresponding bit from output of gate (11), which is equal to B-reg (7) when aim_mux_cntl_hi=‘1’. There are also two byte zero-detection circuits (8) and (9) at bit logic output, blu_out, and aim_out. The blu_aim_mask generation starts during the EM1 cycle. The mask is 64-bits consisting of a sequence of 1's in a 64-bit number. The start and the end of the sequence are identified by two 6-bits fields. When start is equal to the mask end, the mask will only have a single ‘1’ at the bit position identified by start or end.

The task of computing the condition code for the above instructions is broken in simple micro-architecture operations that can execute in parallel on the existing data flow. These micro-operations are executed in the FXU during E1 cycle. The control for the micro-operations, however, starts at the EM1 cycle.

FIG. 5. Shows the blu_aim_mask (0:63) setting for various test under mask instructions. Blu_aim_mask (0:63) will only have single bit ‘1’ at the position of leftmost ‘1’ in the instruction mask, M (0:15). A leading zero detection (LZD) is applied to M (0:15) and the output LZD (0:3) along with instruction type are used to set the start and the end of the blu_aim_mask. The LZD and setting of the mask end and start bit positions are decided during the EM1 cycle.

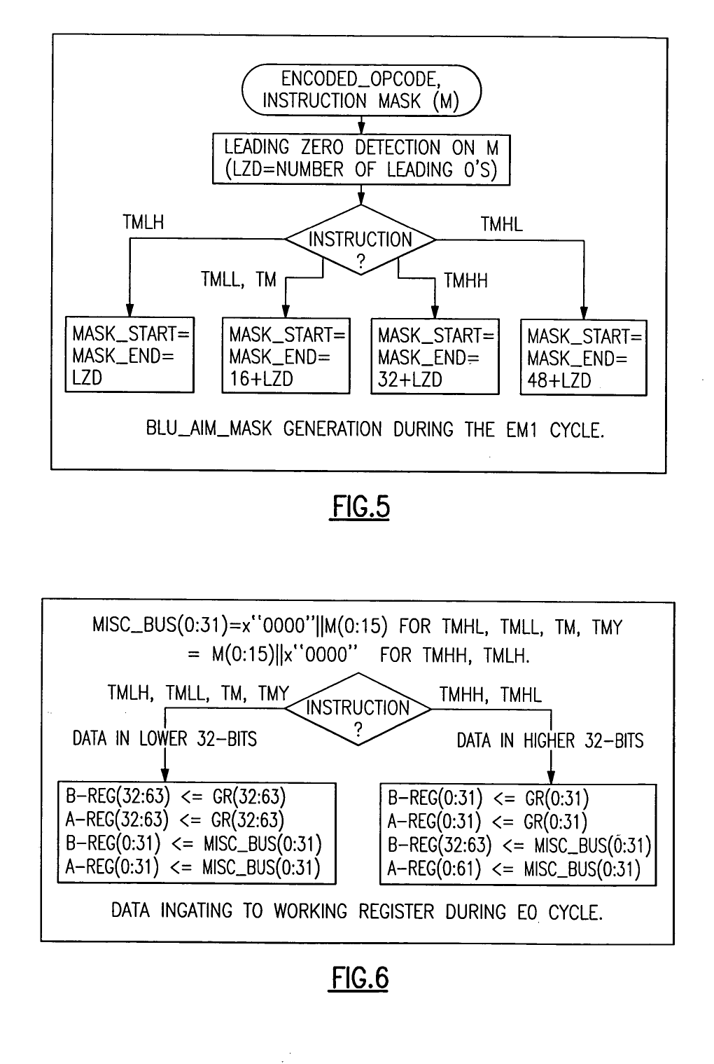

FIG. 6 shows the ingating to A-reg and B-reg working registers during the E0 cycle. First, the misc_bus data is formed from the instruction mask, M, and 0's. Depending on the instruction type A-reg (0:31), A-reg (32:63), B-reg (0:31) and B-reg (32:63) are loaded with GR-data (or cache data for TM and TMY instructions) and misc_bus. For TMLL, TMLH, TM, and TMY, the operand data is loaded into A-reg (32:63) and B-reg (32:63). Data on misc_bus (0:31) is loaded into A-reg (0:31) and B-reg (0:31). For TMHH and TMHL instructions, the operand data is loaded into A-reg (0:31) and B-reg (0:631). Data on the misc_bus (0:31) is loaded into A-reg (32:63) and B-reg (32:63).

The blu_aim_mask is set in EM1 as shown in FIG. 5, the operands are loaded into A-reg and B-reg as shown in FIG. 6, and A-reg is rotated during E1 cycle by 32-bits to left. This rotation properly align Op1 with M, which is a requirement for the implementation. Next, the following four micro-operations are performed in parallel.

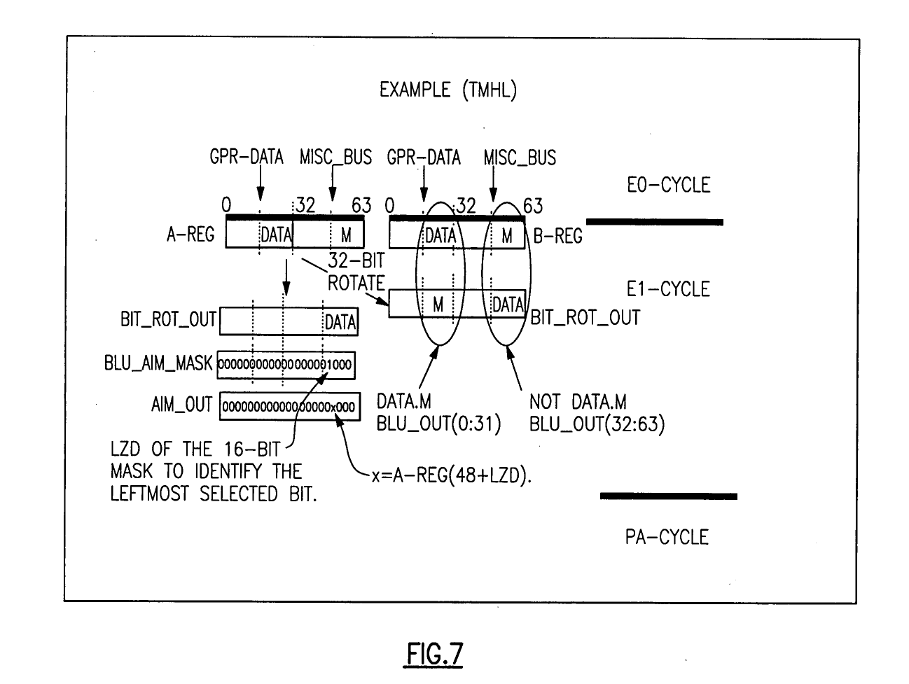

1. Check if selected bits are all 0's. This is implemented by performing the logic ANDing of M (instruction mask) and Op1, and then checking if the result is all 0's. This returns a true value if the result is all 0's. This micro-operation is performed in the BLU_AIM macro. Depending on the instruction, either blu_out (0:31) or blu_out (32:63) contains the value of the ANDing. FIG. 7. shows how TMHL instruction using our preferred embodiment is implemented. Blu_out (0:31)=(Op1 AND M) whereas blu_out (32:63)=(Not Op1 AND M). Again this is achieved by rotating A-reg (0:63) 32 bit to the left and setting blu_and_cntl_hi=‘1’, blu_xor_cntl=blu_xor_sel_hi=‘0’.

2. Check if the mask bits are all 0's. This is done by checking the instruction mask bits. This is known by the LZD value.

3. Check if selected bits are all 1's. This is done by performing the logic ANDing of M and compliment of Op1, and checking if the result is all 0's. For the TMHL instruction implementation, shown in FIG. 7., blu_out (32:63) contains this value. This is achieved by setting control lines blu_an_cntl_lo=blu_xor_sel_lo=1, and blu_xor_sel_lo=‘0’.

4. Check if the left most selected bit is 0 or a 1. This is done by setting the BLU_AIM_MASK (0:63) such that it has a single one bit in the position of the leftmost selected bit. If the instruction mask is all 0's, the blu_aim_mask will be also all 0's. Control signals aim_mux_cntl_hi and aim_mux_cntl_lo are set to ‘0’. The merge function (7) in FIG. 4 selects between the A-reg and 0's. As an example, refer to FIG. 7. Where aim_out (0:63) is all 0's except for aim_out (48+LZD) (=A-reg (48+LZD)). A zero detect on aim_out determines if leftmost selected bit is a ‘0’ or a ‘1’. A true value indicates that leftmost selected in bit is ‘0’ while a false value indicates a value of ‘1’.

Using these four micro-operations, The Condition Code (CC) can be evaluated as follows:

Condition code value of 0. Either micro-operation 1) or 2) is true.

Condition code value of 1. Both micro-operation 1) and 3) are false and operation 4) is true for TMHH, TMHL, TMLL and TMLH.

Micro-operation 1) or 3) are false for TM instruction.

Condition code value of 2. Micro-operation 1), 3) and 4) are false for TMHH, TMHL, TMLL and TMLH.

Condition code value of 3. Micro-operation 3) is true and 2) is false.

FIG. 8 illustrates for convenience of reference the use of the TEST UNDER MASK (TM) instruction illustrated in the Appendix A-31 of the z900 architecture Principles of Operation SA22-7832-00.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. In a computer system, a method for executing a Test Under Mask instruction in the execution stage of a pipeline of the Fixed Execution Unit (FXU) of the computer system, comprising the steps of:
separating the execution stage of a Test Under Mask instruction into different micro-operations that are executed in parallel in one FXU execution cycle, wherein
during a first part of the instruction execution cycle of the FXU loading data from a first operand and from a Test under Mask instruction into two working registers respectively, an A-reg and a B-reg, and then, during a second part of the same execution cycle E1 cycle rotating the A-reg data by the amount of bits in the A-reg to align the bits of the first operand with the corresponding bits of a mask of said Test under Mask instruction, and during the same second part of the same execution cycle E1 executing micro-operations in the Fixed Execution Unit (FXU) giving the highest priority to the leftmost selected bit in the operand to calculate the condition code (CC) and output the outcome of said calculation to implement the Test under Mask as a one-cycle implementation for Test under Mask instructions.

2. The method according to claim 1 comprising the step of performing a leading zero detection (LZD) on the mask field of giving the highest priority to the leftmost selected bit in the operand giving the highest priority to the leftmost selected bit in the operand.

3. The method according to claim 2 wherein the mask field of the Test under Mask instruction is extracted from the instruction text during instruction decode and sent to the FXU during dispatch cycle (EM1).

4. The method according to claim 3 wherein when the mask is filled, it is also checked to determine if it is all 0's.

5. The method The method according to claim 2 further comprising then using the LZD value to set the mask start and mask end for different variants of test under mask instructions.

6. The method according to claim 2 further comprising then using the LZD value to set the mask start and mask end for different variants of test under mask instructions wherein the mask start and mask end are set to LZD for TMLH, LZD+16 for TMLL, LZD+32 for TMHH and LZD+48 for TMHL.

7. The method according to claim 5 wherein is provided for a blu_aim_mask only a single ‘1’ at the position where the leftmost bit is located bit_rot_out.

8. The method according to claim 2 wherein data is formed on a bus (misc_bus (0:31)) determined from the mask field, and said bus data and the first operand data are loaded in the working registers A-reg and B-reg, and then, depending on the instruction type, the A-reg and B-reg are loaded according a predetermined table entry (FIG. 6).

9. The method according to claim 7 wherein to setup the control rotates A-reg contents by 32-bits during the E1 cycle to align the first operand data with the instruction mask data.

10. The method according to claim 9 wherein to setup the control to find out if all the selected bits are 1's, the controls are setup so that to do the ANDing of the compliment of bit_rot_out, the output of the rotate of A-reg contents, and B-reg.

11. The method according to claim 10, wherein
(a) for TMLL, TMLH, TM, and TMY instructions, the high word of the BLU_AIM, specifically blu_out (0:31) is set to produce the result of ((Not Op1) AND M) by performing (Not bit_rot_out (0:31) AND B-reg (0:31)) and a zero detection on blu_out (0:31) decides if all selected bits are 1's; while
(b) for TMHH and TMHL instructions, the low word of the BLU_AIM, specifically blu_out (32:63) is set to produce the result of ((Not Op1) AND M) by performing (Not bit_rot_out (32:63) AND B-reg (32:63)) and a zero detection on blu_out (0:31) decides if all selected bits are 1's.

12. The method according to claim 9 to setup the control to do ANDing of the compliment of bit_rot_out, the output of the rotate of A-reg contents, and B-reg:
A) For TMLL, TMLH, TM, and TMY instructions, the high word of the BLU_AIM, specifically blu_out (0:31) is set to produce the result of (Op1 AND M) by performing (bit_rot_out (0:31) AND B-reg (0:31)) and a zero detection on blu_out (0:31) decides if all selected bits are 0's; while
for TMHH, TMHL instructions, the low word of the BLU_AIM, specifically blu_out (32:63) is set to produce the result of (Op1 AND M) by performing (Not bit_rot_out (32:63) AND B-reg (32:63)) and a zero detection on blu_out (0:31) decides if all selected bits are 0's.

13. The method according to claim 9 wherein control is to find the left most selected bit of the data that is in bit_rot_out, and a blu_mask_out is used to select and merge between bit_rot_out and a vector of 0's to produce a result out (aim_out (0:63)) with all 0's except for a single bit that lines up with the leftmost selected bit when the bit position is the same as mask start and mask end.

14. The method according to claim 13 wherein when test does a zero-detect on the result out (aim_out) and when the mask bit does not equal zero, if aim_out is all 0's, then the leftmost selected bit is a ‘0’ otherwise it is a ‘1’.

15. The method according to claim 1 wherein the test under mask performed in the FXU sets the condition code based on the results.
